(19) United States
(12) Patent Application Publication
(10) Pub. No.: US 2002/0100062 A1
(43) Pub. Date: Jul. 25, 2002

(54) Content with advertisement information segment

(76) Inventors: Jonathan E. Lowthert, Sunnyvale, CA (US); Oleg Rashkovskiy, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/766,133

(22) Filed: Jan. 19, 2001

(51) Int. Cl. H04N 7/025; H04N 7/10; G06F 3/00; H04N 5/445; G06F 13/00; H04N 7/16

(52) U.S. Cl. 725/136; 725/32; 725/42

(57) ABSTRACT

An apparatus and method for creating an info segment which specifies interruption points at which a first content item should be interrupted in favor of a second content item. The info segment may prevent certain types of second content items from being utilized, may permit them to be avoided, may control their duration, and other aspects of their utilization. The info segment may specify with which first content item it is associated.

### RELATED APPLICATIONS

This application is related to application Ser. No. ______ and application Ser. No. ______, by these inventors and filed concurrently herewith.

### BACKGROUND OF THE INVENTION

1. Technical Field of the Invention

The present invention relates generally to insertion of advertisements or the like into content such as a movie.

2. Background Art

In present content distribution systems, advertisements are permanently, directly attached to the content with which they are distributed, on the same distribution medium. Rental video tapes typically contain several advertisements at the beginning of the tape, before the movie content begins. In general, the content itself will have a much longer “shelf life” than the advertisements. For example, consider a videotape or DVD copy of a highly successful motion picture, with a commercial at the beginning of the tape or DVD advertising a different movie which had not yet reached theaters at the time the tape was originally released, and which may thereafter have proven to be a complete flop. That videotape or DVD may be rented for dozens of years to come, with the now-pointless advertisement playing each time. As another example, consider a home videotape copy of a Superbowl football game, during which were shown: a commercial for a new model automobile, a commercial for a limited-time home mortgage offer, and a commercial for an after-Christmas furniture sale. Those commercials become useless quickly, in some cases in mere days.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 shows one embodiment of a system constructed according to the principles of this invention.

FIG. 2 shows one embodiment of a program which includes a content item and an info segment.

FIG. 3 shows the contents of one embodiment of an info segment such as may be used in practicing this invention.

FIG. 4 shows the contents of one embodiment of an ad entry such as may be used in such an info segment.

FIG. 5 shows another embodiment of a program which includes such an info segment used in conjunction with a content item which includes markers.

FIG. 6 shows another embodiment of a program which includes a content item and info segment pointers which point to such an info segment.

FIG. 7 shows an electronic programming guide which includes info segments for the respectively associated content items.

FIG. 8 shows one embodiment of a method for generating an info segment such as that shown in FIG. 3.

FIG. 9 shows one embodiment of a method for generating an ad entry such as that shown in FIG. 4.

FIG. 10 shows one embodiment of a method for operating an ad server such as that shown in FIG. 1.

FIG. 11 shows one embodiment of a method for operating an info segment server such as that shown in FIG. 1.

FIG. 12 shows one embodiment of a method for operating a receiver such as that shown in FIG. 1.

### DETAILED DESCRIPTION

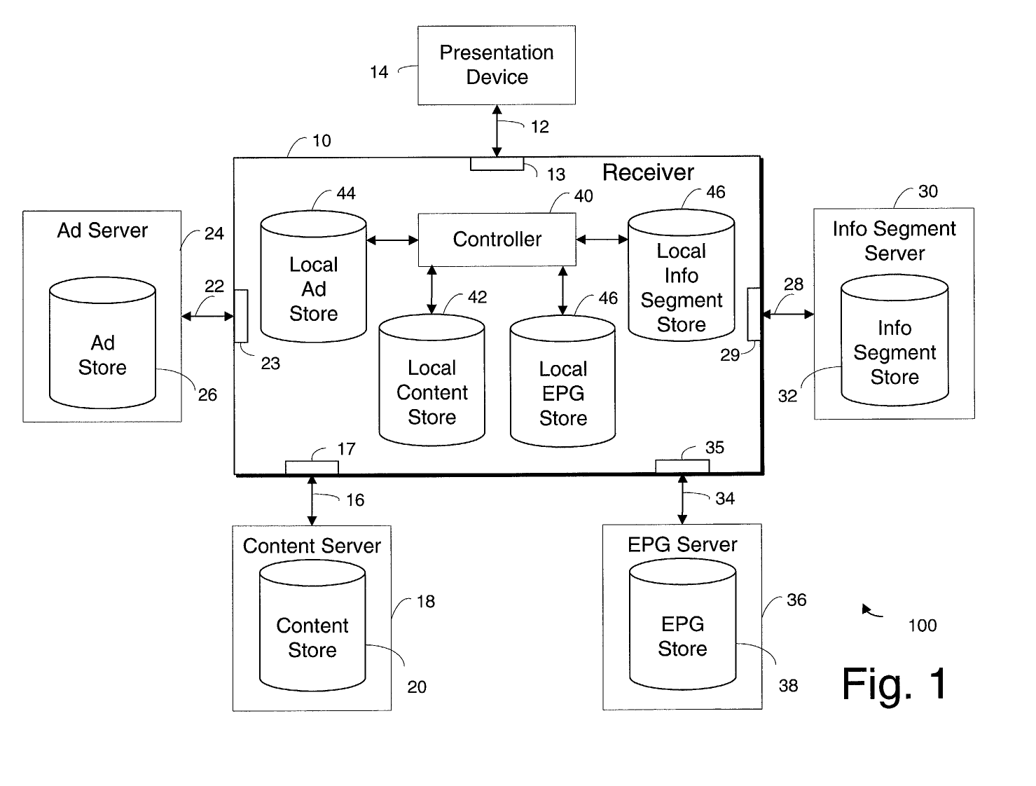

FIG. 1 illustrates one embodiment of a system 5 constructed according to the principles of this invention. The system includes a receiver 10 which is coupled over a presentation link 12 at a presentation device port 13 to a presentation device 14. In various embodiments, the presentation device may be an audio speaker, a video screen, an audio-visual combination device, or other suitable apparatus over which a user may enjoy content such as entertainment programming. The presentation link may be a wire, a wireless connection, an infrared connection, or any other suitable communications mechanism. The port may be any form of suitable connection means.

The receiver is further coupled over a content link 16 at a content port 17 to a content server 18 which includes a content store 20. The content server may be, for example, a television broadcast station, a television cable head-end, a website, a movie production house, or any other producer or provider of user-consumable content, such as entertainment programming, television shows, movies, or the like.

The receiver is also coupled over an ad link 22 at an ad port 23 to an ad server 24 which includes an ad store 26. The ad link, ad server, and ad store will be discussed in terms of storing and delivering advertising content, but the skilled reader will understand that the teachings of this invention may be utilized in providing other types of content which is to interrupt the primary content from the content store. Examples of such other types of content may include digital gift certificates, hyperlinks, links to ATVEF presentations, questionnaires, or other content.

The receiver is further coupled over an info segment link 28 at an info segment port 29 to an info segment server 30 which includes an info segment store 32.

The receiver may also optionally be coupled over an electronic programming guide (EPG) link 34 at an EPG port 35 to an EPG server 36 which includes an EPG store 38.

The content link, ad link, info segment link, and EPG link may each be a wire, a wireless broadcast mechanism, a coaxial cable system, a laser point-to-point link, the internet, a modem, a satellite dish network, a CD-ROM or DVD or the like, “sneakernet”, or other suitable delivery means. They may all be carried on a common link, or each may be a separate and different type of link, or any combination thereof.

The receiver 10 includes a controller 40 which governs the operation of the receiver. To the controller are coupled a local content store 42, a local ad store 44, a local info segment store 46, and an optional local EPG store 48. In some embodiments, these local stores may be constructed as separate storage elements, while in other embodiments, various combinations of them may be constructed to share a common storage element. The storage element(s) may utilize videotape, digital videotape, hard disk, CD-R, CD-RW, DVD-R, semiconductor memory, or any other suitable storage mechanism(s).

Various ones of the various ports and links may, in some embodiments, be internal to the receiver. In some embodiments, there may be more than one of each port and link. In some embodiments, various of the links may be combined.

The phrase “server” is used by way of illustration. The skilled reader will appreciate that the principles of this invention are not limited to a server-client implementation model.

Please make continued reference to FIG. 1 throughout the following explanation.

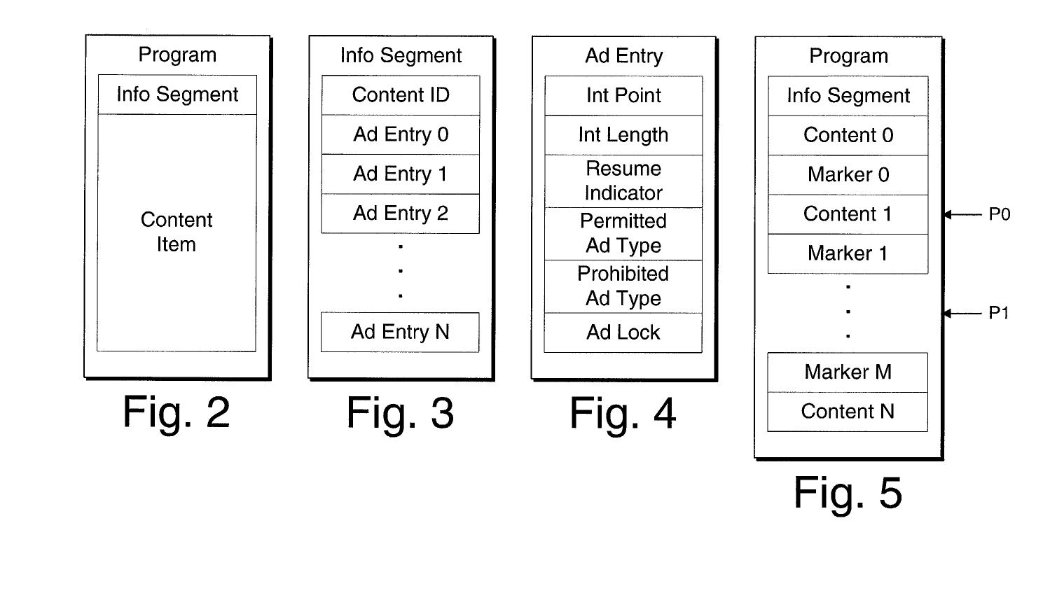

FIG. 2 illustrates one embodiment of a program which includes an info segment and a content item. The info segment is provided to the receiver by the info segment server, and the content item is provided to the receiver by the content server. FIG. 2 may be understood to represent a data stream which contains the info segment and the content item. FIG. 2 may also be understood to represent a recording mechanism upon which are recorded the info segment and the content item. The reader will appreciate that there is not any order implied in the representation, and that the info segment could be recorded or transmitted at the start, at the end, in the middle, in a unitary block, scattered in pieces throughout the content item, as a single instance, as repeated instances, and so forth.

FIG. 3 illustrates one exemplary embodiment of an info segment which may be provided over the info segment link from the info segment server. In some embodiments of the program of FIG. 2, there may be an implicit association between the info segment header and the content item. For example, if the program is provided on a videotape which contains only a single movie—the content item—there will be a single info segment for that movie. In such a case, the content identifier may be regarded as null. The null content identifier may be one that is ignored, or there may simply not be one. In other embodiments, in which the association between the info segment and the content item is not implicit, the info segment will contain a non-null content identifier (Content ID) which specifies with which content item the info segment is associated. In one embodiment, the content identifier may be, for example, a copy of (or a hashed value of) an initial portion of closed caption text in the content item. In another embodiment, the content identifier may be a programming guide reference number of the program, such as a VCR+number. Other associative mechanisms will be apparent to the reader upon studying this disclosure.

The info segment also contains one or more ad entries (Ad Entry 0-N), which may be stored in any suitable manner, such as a table, a linked list, or the like. The various fields of a given ad entry may be stored contiguously together, or like fields of the multiple ad entries may be stored together.

FIG. 4 illustrates the contents of an exemplary ad entry. In various embodiments, various ones of the fields in an ad entry may be optional, as suitable for the implementation. In some embodiments, the ad entry may contain an interrupt point identification (Int Point) which indicates a point during the content item at which an advertisement should be inserted, interrupting the play of the content item. In some embodiments, play of the content item should be suspended until the advertisement is done. In other embodiments, play of the content item may continue during the advertisement; in such embodiments, the “interruption point” is really an “insertion point”. The interrupt point identification may specify the interruption point in any of a variety of fashions. In one embodiment, it may indicate a time, relative to the start of the content item, at which the ad should be inserted; e.g. “play commercial fifteen minutes into the movie”. In another embodiment, it may indicate a time relative to a most-recently-inserted advertisement; e.g. “play commercial ten minutes after the prior commercial”. In another embodiment, some metric other than time could be used, such as a byte or block count; e.g. “play commercial after one million blocks of the movie have been decoded and played”. In yet another embodiment, the interrupt point identification may specify a content-specific event such as “when the volume goes to zero, play a commercial” or “when there are two consecutive frames of all black, play a commercial” or the like. In yet another embodiment, the interrupt point identification may specify a play-specific factor such as “after the song has been played three times in one month, play a commercial”.

In some embodiments, the ad entry may include an interrupt length (Int Length) specifier of how long the commercial is; e.g. “at this point, insert a thirty-second-long commercial”. A variant of that is “play a commercial, but if it tries to run longer than thirty seconds, cut it off and return to the content”.

In some embodiments, the ad entry may include a resume indicator (Resume Indicator) which may further control the ability of the interrupting advertisement to seize undue control over the playing of the primary content item. One such resume indicator may be, for example, “insert a commercial, but allow the user to override it by hitting the <enter>button on the remote control”. One commercially interesting variant of this might be “insert a commercial, but terminate it if the user hits the <payment>button” upon which some nominal fee may be automatically charged to the user's predetermined account. Fees from such payments could be divided between the content provider and the advertiser.

The ad entry may further include, in some embodiments, a permitted ad type identifier (Permitted Ad Type) and/or a prohibited ad type identifier (Prohibited Ad Type) which, when taken together or alone, may impose limitations upon the type, rating, source, content, or other aspect of advertisement which is allowed by the content provider, the advertiser, and/or the user to be inserted at the specified point. For example, Disney may not want its movies to be interrupted with advertisements which contain nudity. Similarly, Marlboro may wish to prevent its advertisements from being shown during any children's' television program. Or a parent may wish to prevent any advertisements containing profanity, or advertising alcoholic beverages, from being played in their home at any time.

The ad entry may also include additional fields to control various additional aspects of the content/advertisement/audience relationship. As one example, the ad entry may include an ad lock (Ad Lock) field which serves as an override to the interruption by the advertisement. In one embodiment, the ad lock field may be used to cause an advertisement to be played if the user has only rented the videotape, but to skip the advertisement if the user has purchased the videotape. Other uses or heuristics are of course conceivable. For example, the ad lock may permit suppression of the commercial if the time is after ten o'clock at night, or if the user has already viewed twenty-five commercials that day, and so forth.

It is not necessarily required that all ad entries in a given info segment contain exactly the same fields. For example, one ad entry may lack a permitted ad type specifier, while another ad entry in the same info segment may lack an ad lock, while yet another may lack everything but the interrupt point identifier. If it is desired that all ad entries be the same size, then the unused fields may simply be left blank, or they may be filled with some predetermined value indicating non-use. In other embodiments, it may be desirable to minimize the size of the info segment, and, in such cases, it may be suitable to permit ad entries of different sizes, so unused fields do not occupy any bytes.

FIG. 5 illustrates an alternative embodiment of the program, in which the content item is not stored as a contiguous block, but is stored in separate blocks (Content 0-N) between which are interlaced one or more markers (Marker 0-M). In such an embodiment, rather than specifying specific offset times for commercial insertion, the info segment may instead specify that commercials should be inserted at markers. For example, if a viewer tunes in when the content broadcast has already progressed to point P0, the slot (Marker 0) for the first commercial has already passed. Rather than selling “the ad slot at time 15:00 into the broadcast” to the advertiser, it may be desirable to sell “the first ad slot that any given viewer encounters”. In this case, the first commercial will be inserted at the first slot (Marker 1) which this particular viewer encounters, rather than the slot (Marker 0) which has already passed. The reader will appreciate that this business model can be practiced without insertion of such markers; but that markers may be one advantageous embodiment.

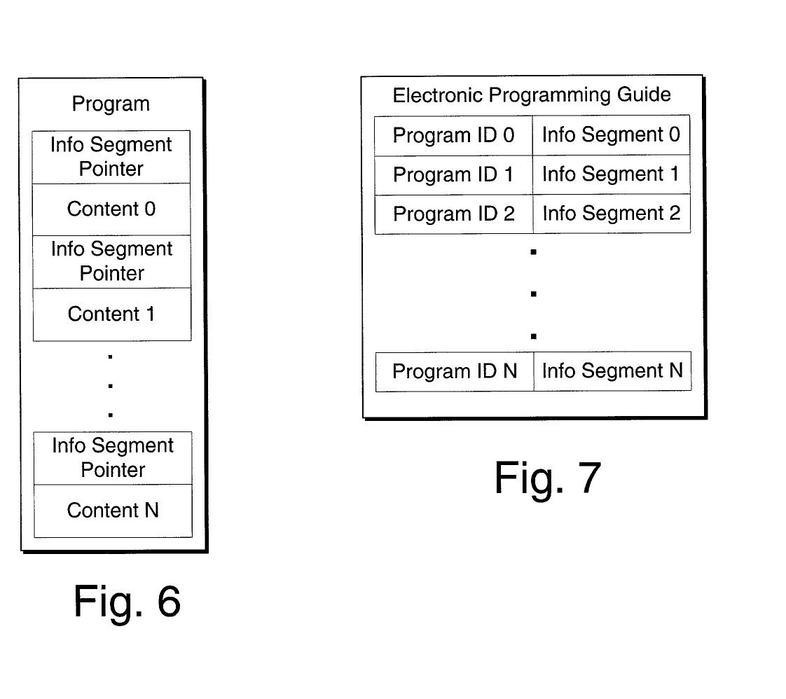

FIG. 6 illustrates another alternative embodiment of the program, in which the info segment is not actually inserted into the program. In the embodiment illustrated by FIG. 5, it was assumed that the info segment had been captured by the receiver, either at the time it was originally broadcast (even though the viewer had not yet tuned in that particular broadcast), or immediately when the viewer tuned in that program. This may not always be practical, in some cases due to the size o the info segment and the limited storage provided in the receiver. As illustrated in FIG. 6, the program may contain info segment pointers (Info Segment Pointer), such as URLs or the like, which take far less bandwidth and storage than the complete info segment. Thus, the pointers may be repeated periodically throughout the broadcast of the content item. The first time the receiver encounters a pointer, it may fetch the info segment.

FIG. 7 illustrates an electronic programming guide (EPG) as modified for use with this invention. The EPG includes one or more program identifiers (Program ID0-N), each of which provides programming guide information for a particular program, such as channel, start time, ending time, a textual or other listing of its stars and director, and so forth. Associated with each of one or more of the program identifiers is an info segment (Info Segment 0-N) which provides the mapping of advertisements for the associated program.

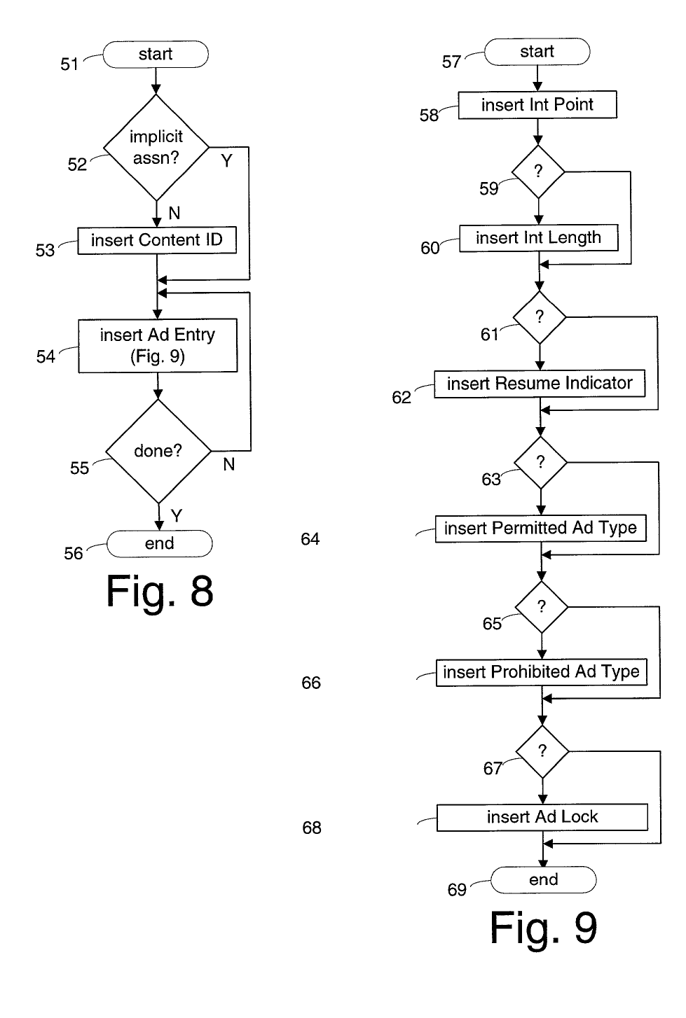

FIG. 8 illustrates one embodiment of a method for generating an info segment, and should be read in conjunction with FIG. 3. The method begins at a starting point (51). If (52) there is an implicit association between the info segment and the content item to which it pertains, then the method may optionally skip the insertion (53) of the content identifier (Content ID). Then, the method inserts (54) at least one ad entry (Ad Entry 0). If (55) there are more ad entries to be inserted, then the method iterates through the insertion (54) of the ad entries until there are no more to be inserted. Then the method is finished (56). The reader will appreciate that an info segment may be ordered, structured, formatted, protected, encrypted, compressed, and so forth, according to the needs of the application.

FIG. 9 illustrates one embodiment of a method for generating an ad entry, and should be read in conjunction with FIG. 4. The method shown in FIG. 9 may be utilized to perform the insertion of the ad entry, in FIG. 8. The method begins at a starting point (57). In embodiments where it is required, the method inserts (58) an interrupt point identification (Int Point). If (59) it is required, the method inserts (60) an interrupt length specifier. If (61) it is required, the method inserts (62) a resume indicator. If (63) it is required, the method inserts (64) a permitted ad type identifier. If (65) it is required, the method inserts (66) a prohibited ad type identifier. If (67) it is required, the method inserts (68) an ad lock. Finally, the method ends (69). The reader will appreciate that an ad entry may be ordered, structured, formatted, protected, encrypted, compressed, and so forth, according to the needs of the application.

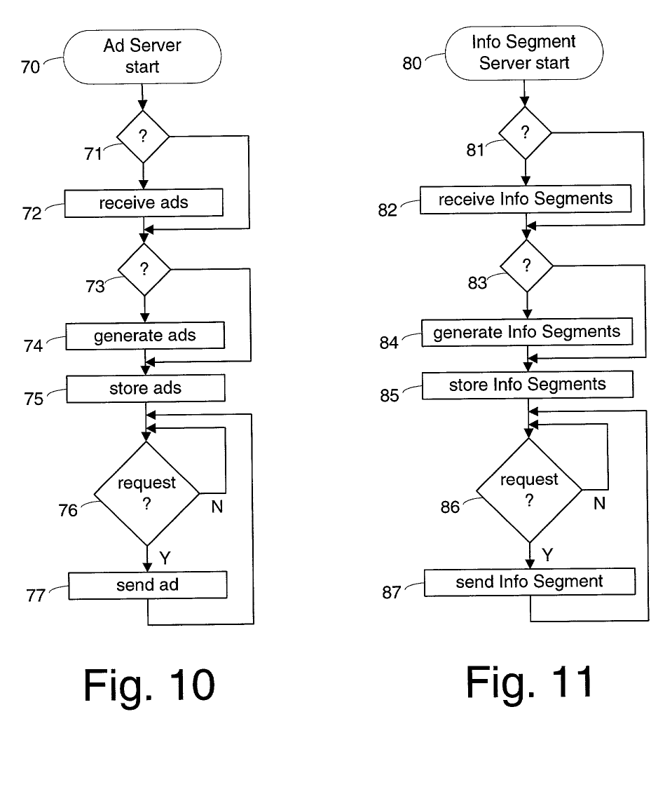

FIG. 10 illustrates one embodiment of a method for operating an Ad Server such as that shown in FIG. 1. The method begins at a starting point (70). The ad server may optionally (71) receive ads (72) from external sources. The ad server may also optionally (73) generate ads (74) itself. The ad server stores the ads in an ad store. In a “pull” model, the ad server waits (76) for requests for ads, then retrieves those ads from the ad store (or it could even generate or fetch them on the fly), and sends the ads (77) to the requester over an ad link. The ad server then returns to wait for additional requests. In a “push” model, the ad server would not wait for requests, but would proactively deliver ads without waiting for requests.

FIG. 11 illustrates one embodiment of a method for operating an Info Segment Server such as that shown in FIG. 1. The method begins at a starting point (80). The info segment server may optionally (81) receive info segments (82) from external sources. The info segment server may also optionally (83) generate info segments (84) itself The info segment server stores the info segments in an info segment store. In a “pull” model, the info segment server waits (86) for requests for info segments, then retrieves those info segments from the info segment store (or it could even generate or fetch them on the fly), and sends the info segments (77) to the requester over an info segment link. The info segment server then returns to wait for additional requests. In a “push” model, the info segment server would not wait for requests, but would proactively deliver info segments without waiting for requests.

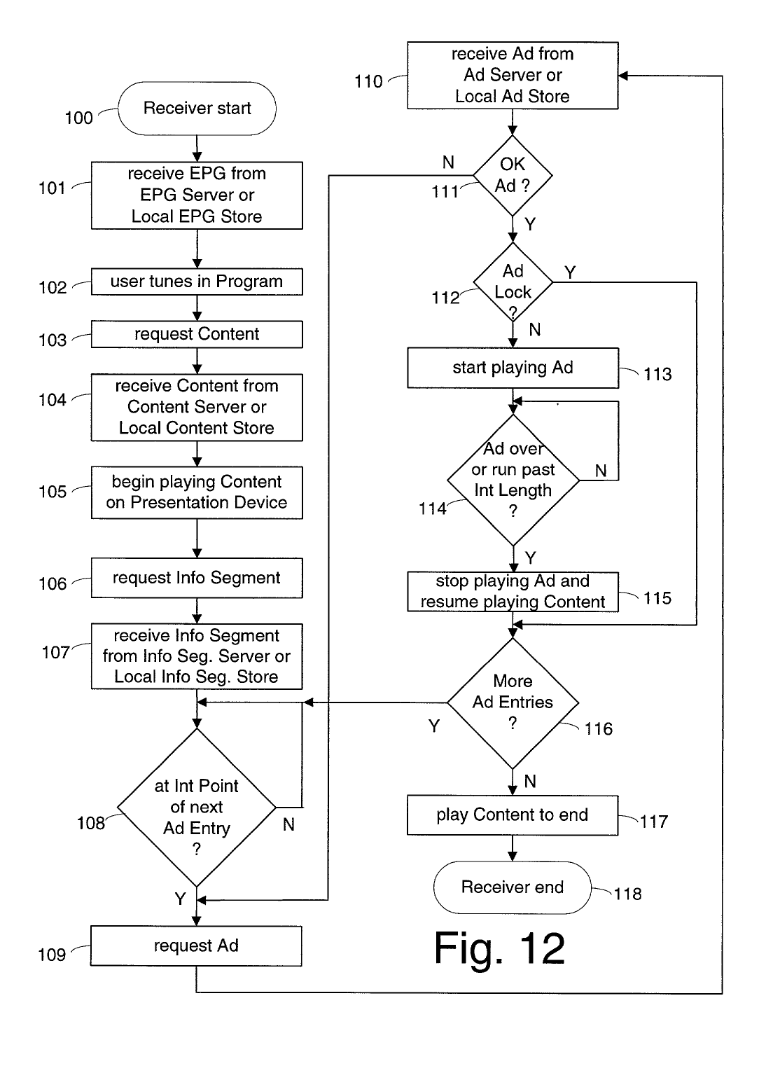

FIG. 12 illustrates one embodiment of a method for operating a Receiver such as that shown in FIG. 1, to which the reader should refer. The method begins at a starting point (100). The Receiver may receive (101) an electronic programming guide (EPG) from an EPG Server, or from the Local EPG Store if it has previously been received and cached. This may be done in the background, without direct user input. The user tunes in (102) a program, or the Receiver may do this automatically, such as if the user has programmed the Receiver to always tune in a particular program. The Receiver requests (103) content for that program, and then receives (104) the content from the Content Server or from the Local Content Store if it has previously been received and cached. The Receiver begins to play (105) the content on the Presentation Device. The Receiver requests (106) an info segment for that program, and receives (107) the info segment from the Info Segment Server, or from the Local Info Segment Store if it has previously been received and cached; in that case, it may then also check to see if the locally stored info segment is still valid or current.

During play of the content, the receiver waits (108) until play reaches the first interruption point identified in the info segment. At that point, the receiver requests (109) an ad, and receives (110) the ad from the Ad Server or from the Local Ad Store if the ad has previously been received and cached. If (111) the ad and content do not, together, meet the criteria specified by the Permitted Ad Type and Prohibited Ad Type specifiers, the Receiver requests (109) another ad. If (112) the Ad Lock indicator says to this ad may not be skipped, or the requisite conditions are met for skipping the ad, then the Receiver interrupts play of the content and begins (113) playing the ad instead. If (114) the ad runs longer than permitted by the Int Length specifier, or the ad ends, the Receiver stops (115) playing the ad and resumes playing the content. If (116) there are more ad entries, control returns to wait for the next interruption point (108). If (112) the Ad Lock indicator permits the ad to be skipped, and if the requisite conditions are met, no ad will be played, and the method will check (116) if there are more ad entries; in such a case, it may be that the Receiver should play the already-retrieved ad rather than fetching a new one, at the next interruption point. Ultimately, the content is played (117) to its end and the method finishes (118).

The reader should appreciate that FIGS. 8-12 each represents both a process for performing a respective method, as well as a recordable medium or other instruction delivery mechanism in which is encoded or recorded or otherwise represented a series of instructions, routines, firmware, or control codes or the like which, when executed by a computer device or loaded as firmware or control codes into a programmable hardware device or provided as inputs to a runtime interpreter or the like, cause such hardware or software to perform the respective method. The reader should also appreciate that FIGS. 2-7 each represents both a respective data entity and a recordable medium or other data delivery mechanism in which is encoded or recorded or otherwise represented that data entity. Instruction and data delivery mechanisms (and the various links described above) include, but are not limited to: magnetic tape, optical discs, DVD, DVD-R, DVD-RW, CD, CD-ROM, CD-R, CD-RW, floppy disk, hard drive, removable hard drive, semiconductor memory device, and the like, as well as down-the-wire, over-the-airwaves, wireless packet, cable television signal, laser-carried, internet protocol delivery, and other such forms of delivery mechanism.

The reader should appreciate that, while the invention has been described with reference to the interruption of a first content item for the playing of a second content item which has been described above as being an advertisement, it is not necessary that the second content be a commercial advertisement. The invention may be used in interrupting any type of first content item for the play of any type of second content item. The content items may be video, audio, audio/video, text, or any other suitable form of data. The receiver may, in some embodiments, contain an integral presentation device. In others, the presentation device may be external. The invention may readily be utilized in a wide variety of applications; for example, the receiver may be a DVD player, a CD player, a video player, an audio player, an e-book viewer, or any other suitable device.

Finally, the reader should appreciate that in various embodiments of the system, various of the servers' functions may be performed by a single, combined entity. For example, the ad server and the info segment server could be a single server, or the content server and the info segment server could be built as a single entity, or all four servers could share a common platform, and so forth.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may” “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An apparatus comprising:
(A) means for receiving at least one info segment, each info segment including,
(1) a content identifier, and
(2) a plurality of ad entries, each ad entry having,
(a) an interruption point specifier;
(B) an info segment store adapted to store the at least one info segment;
(C) means for receiving from a receiver an info segment request which includes a program identification of a program which the receiver is to display;
(D) means for locating one of the info segments whose content identifier matches the program identification; and
(E) means for sending the one info segment to the receiver.

2. The apparatus of claim 1 wherein at least one ad entry of at least one of the info segments further has:
(b) a maximum interruption length specifier.

3. The apparatus of claim 1 wherein at least one ad entry of at least one of the info segments further has:
(c) a resume indicator.

4. The apparatus of claim 1 wherein at least one ad entry of at least one of the info segments further has:
(d) a prohibited ad type specifier.

5. The apparatus of claim 1 wherein at least one ad entry of at least one of the info segments further has:
(e) a permitted ad type specifier.

6. The apparatus of claim 1 wherein at least one ad entry of at least one of the info segments further has:
(f) an ad lock specifier.

7. The apparatus of claim 1 wherein:
at least one ad entry of at least one of the info segments further has,
(b) a maximum interruption length specifier;
at least one ad entry of at least one of the info segments further has,
(c) a resume indicator;
at least one ad entry of at least one of the info segments further has,
(d) a prohibited ad type specifier;
at least one ad entry of at least one of the info segments further has,
(e) a permitted ad type specifier; and
at least one ad entry of at least one of the info segments further has,
(f) an ad lock specifier.

8. The apparatus of claim 1 further comprising:
means for generating an info segment.

9. An apparatus comprising:
(A) an info segment store adapted to store at least one info segment, each info segment including,
(1) a content identifier, and
(2) at least one ad entry, each ad entry having,
(a) an interruption point specifier;
(B) an electronic programming guide store adapted to store at least one EPG entry each describing a predetermined program and having a program identification;
(C) means for receiving from a receiver an EPG request which includes a program identification of a program which the receiver is to display;
(D) means for locating an EPG entry and an info segment whose content identifiers match the program identification of the EPG request; and
(E) means for sending the located EPG entry and info segment to the receiver.

10. The apparatus of claim 9 wherein:
at least one ad entry of at least one of the info segments further has,
(b) a maximum interruption length specifier;
at least one ad entry of at least one of the info segments further has,
(c) a resume indicator;
at least one ad entry of at least one of the info segments further has,
(d) a prohibited ad type specifier;
at least one ad entry of at least one of the info segments further has,
(e) a permitted ad type specifier; and
at least one ad entry of at least one of the info segments further has,
(f) an ad lock specifier.

11. An apparatus comprising:
(A) a content store adapted to store at least one content item;
(B) an info segment store adapted to store at least one info segment, each info segment including,
(1) a content identifier, and
(2) at least one ad entry, each ad entry having,
(a) an interruption point specifier;
(C) means for receiving from a receiver a program request which includes a program identification of a program which the receiver is to display;
(D) means for retrieving a content item from the content store and an info segment from the info segment store, which content item and info segment match an identification of the requested program; and
(E) means for sending the retrieved content item and the retrieved info segment to the receiver.

12. The apparatus of claim 11 wherein at least one ad entry of at least one of the info segments further comprises one or more specifiers selected from the group comprising:
(b) a maximum interruption length specifier;
(c) a resume indication specifier;
(d) a prohibited ad type specifier;
(e) a permitted ad type specifier; and
(f) an ad lock specifier.

13. A method of creating an info segment for a first content item, the method comprising:
inserting a content identifier which associates the info segment with the content item; and
inserting at least one entry, each entry including, an insertion point specifier which specifies a point at which, during play of the first content item, play of the first content item should be interrupted and a second content should be played.

14. The method of claim 13 further comprising:
inserting a plurality of such entries.

15. The method of claim 13 wherein in the inserting at least one entry, each entry further includes:
a specifier prohibiting insertion of a specified type of second content item.

16. The method of claim 15 wherein the specifier prohibits insertion of second content item based a characteristic of the second content item selected from the group comprising:
language content of the second content item;
sexual content of the second content item;
violence content of the second content item; and
product type advertised in the second content item.

17. The method of claim 13 wherein in the inserting at least one entry, each entry further includes:
a specifier permitting insertion of a specified type of second content item.

18. The method of claim 13 wherein:
the content identifier is null and the info segment is implicitly associated with the first content item; and
the info segment includes a plurality of entries.

19. The method of claim 13 wherein second content items are advertisements, and each of the at least one entry further includes:
a maximum interruption length specifier which prevents an advertisement from interrupting the first content item for more than a specified amount of time;
an ad type specifier which controls which prevents an advertisement from interrupting the first content item if the advertisement is of a prohibited type; and
an ad lock specifier which enables the advertisement to be skipped if a criterion is met.

20. The method of claim 19 wherein the criterion is the first content item having been purchased rather than rented.

21. The method of claim 13 wherein each entry further includes:
a resume indicator which permits a user to abort the second content item and return to the first content item.

22. A method comprising:
(A) storing a plurality of info segments, each info segment including,
(1) a content identifier associating the info segment with a predetermined content item,
(2) a plurality of ad entries, each ad entry including,
(a) an interrupt point specifier, indicating an interruption point during the predetermined content item at which play of the predetermined content item should be interrupted and an advertisement should be played;
(B) receiving a request for an info segment associated with a specified content item; and
(C) providing the info segment associated with the specified content item.

23. The method of claim 22 wherein each ad entry further includes:
(b) an ad type specifier which prevents ads having a predetermined characteristic from being played at the interruption point.

24. The method of claim 23 wherein the content identifier is null and the info segment is implicitly associated with the predetermined content item.

25. The method of claim 23 wherein each ad entry further includes:
(c) an ad lock specifier which enables the interruption point to be skipped.

26. The method of claim 25 wherein each ad entry further includes:
(d) a maximum interruption length specifier which enables the advertisement to be prematurely terminated if the advertisement is too long.
